(19) United States
(12) Patent Application Publication
(10) Pub. No.: US 2026/0257311 A1
(43) Pub. Date: Sep. 3, 2026

(54) MAINTAINING PART STABILITY DURING SIDE MILLING

(71) Applicant: The Boeing Company, Arlington, VA (US)

(72) Inventor: Justin Lee Peters, Carrollton, IL (US)

(21) Appl. No.: 19/402,491

(22) Filed: Nov. 26, 2025

Related U.S. Application Data
(60) Provisional application No. 63/765,004, filed on Feb. 28, 2025.

(51) Int. Cl. B23Q 15/12

(52) U.S. Cl. CPC B23Q 15/12

(57) ABSTRACT

Methods of maintaining part stability for side milling are presented. Stock to leave is modeled for a roughing operation of a part based on material properties of the material of the raw stock and a design of the part. A finishing toolpath for the side milling is generated based on the stock to leave, minimum wall thickness of the part, maximum stock height, and a number of machining levels.

### CROSS-REFERENCE TO RELATED APPLICATION

This application claims the benefit of U.S. Provisional Patent Application Serial No. 63/765,004, filed February 28, 2025, and entitled “Maintaining Part Stability during Side Milling,” which is incorporated herein by reference in its entirety.

### BACKGROUND INFORMATION

### 1. Field:

The present disclosure relates generally to machining and more specifically to maintaining part stability during machining.

### 2.Background:

Currently, for roughing in manufacturing operations, an engineer or Numerical Control (NC) Programmer will decide stock to leave for each computer aided manufacturing (CAM) roughing operation. The engineer or Numerical Control (NC) programmer uses their experience and judgment to select a perceived adequate stock to leave for maintaining part stability with side milling of multiple levels for thin-walled part features. Such decisions rely upon the knowledge and physical tasks of a production engineer. The CAM systems rely on the knowledge of the user to input variables to maintain part stability for roughing operations with various finishing methods. No standardization is applied, and the outcome results can vary, potentially causing chatter to the part surfaces.

Therefore, it would be desirable to have a method and apparatus that takes into account at least some of the issues discussed above, as well as other possible issues. For example, it would be desirable to have a standard method to maintain part stability for side milling. Additionally, it would be desirable to have a method to automatically determine rough stock to leave to maintain part stability for side milling.

### SUMMARY

An embodiment of the present disclosure provides a method of maintaining part stability for side milling. Stock to leave is modeled for a roughing operation of a part based on material properties of the material of a raw stock and a design of the part. A finishing toolpath is generated for the side milling based on the stock to leave, minimum wall thickness of the part, maximum stock height, and a number of machining levels.

Another embodiment of the present disclosure provides a method of maintaining part stability for side milling. A series of physical machining tests is performed to gather stiffness data for a material over a series of thicknesses and a series of cutting forces. A machining ratio is established for the material based on the stiffness data, the machining ratio comprising a ratio of part thickness to stock height. Stock to leave is set for a roughing operation of a part based on the machining ratio for the material and a design of the part.

Yet another embodiment of the present disclosure provides a method of maintaining part stability for side milling. A point load representative of dynamic cutting forces during machining is calculated. Deflections of a part from the point load are modeled by applying the point load to the part in a physics based modeling. Stock to leave is set for a roughing operation of the part from raw stock based on the deflections.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a final part shape with stock to leave in accordance with an illustrative embodiment;

FIG. 4 is an illustration of a cross-sectional view of a final part shape with stock to leave in accordance with an illustrative embodiment;

FIG. 5 is an illustration of an isometric view of a final part shape with stock to leave in accordance with an illustrative embodiment;

FIGS. 6A and 6B are a flowchart of a method of maintaining part stability for side milling in accordance with an illustrative embodiment;

FIG. 7 is a flowchart of a method of maintaining part stability for side milling in accordance with an illustrative embodiment;

FIG. 8 is a flowchart of a method of maintaining part stability for side milling in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

The illustrative examples recognize and take into account several considerations. The illustrative examples recognize and take into account that existing solutions are suboptimal for automation and have several manually performed tasks utilizing the knowledge and physical task of a production engineer or Numerical Control (NC) Programmer. The illustrative examples recognize and take into account that currently an engineer decides the stock to leave for each computer aided manufacturing (CAM) roughing operation to maintain part stability with side milling of multiple levels for thin-walled part features. The illustrative examples recognize and take into account that CAM systems rely on the user's expertise to input variables and model NC geometry to maintain part stability. The illustrative examples recognize and take into account that this dependence on individual knowledge can result in variability in outcomes, as different users may apply different methods and parameters.

The illustrative examples recognize and take into account that currently there is no method in CAM to automatically define the stock to leave to adaptively maintain part stability with side milling of multiple levels for thin-walled part features for rapid manufacturing processes. The illustrative examples recognize and take into account that the CAM systems currently rely on the knowledge of the user to input variables to maintain part stability for roughing operations with various finishing methods.

The illustrative examples recognize and take into account that no standardization is currently applied for stock to leave for roughing and the outcome results can vary causing chatter to the part surfaces if not applied properly. Traditional methods utilize manual design modeling and user input from production engineers or Numerical Control (NC) programmers to determine the stock to leave from roughing operations for finishing operations. This manual input is done for each new model, making the process time-consuming and labor-intensive. The illustrative examples recognize and take into account that this manual process is time-consuming, prone to variability, and lacks standardization, often leading to suboptimal results such as part distortion or surface chatter.

The illustrative examples provide an automated, standardized solution that can consistently determine the appropriate stock to leave, ensuring part stability and improving the efficiency and reliability of rapid manufacturing processes. The illustrative examples improve upon current CAD modeling NC geometry input and decision-making. The illustrative examples automatically model the stock to leave for adaptively maintaining part stability during side milling. The illustrative examples allow for the manufacturing process to be standardized and produces consistent results. The illustrative examples reduce or eliminate material issues such as surface chatter and part distortion. The illustrative examples can increase part quality and decrease rework.

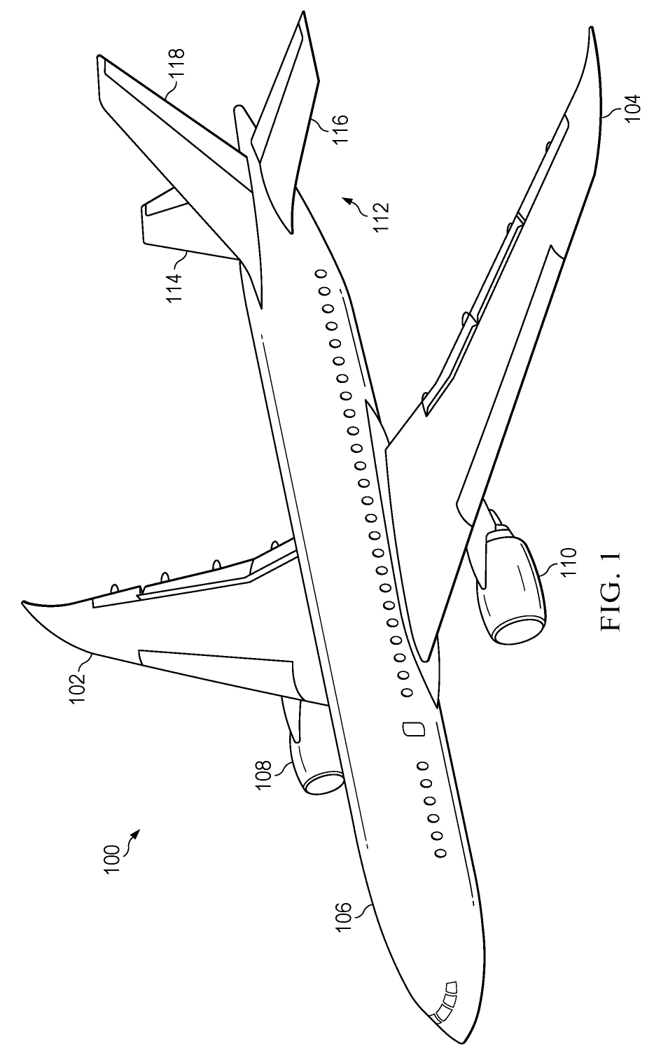

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114 , horizontal stabilizer 116, and vertical stabilizer 118 are attached to tail section 112 of body 106.

Aircraft 100 is an example of an aircraft that can have components formed using the methods of the illustrative examples. The illustrative examples can be used to manufacture components of aircraft 100 without chatter. The illustrative examples can be used to automatically set stock to leave for side milling parts of aircraft 100.

The illustrative examples present automated methods to adaptively maintain part stability during side milling of multiple levels for thin-walled part features in rapid manufacturing processes. Some of the illustrative examples establish a constant machining ratio for various material types to ensure part stability. Additionally, the illustrative examples analyze geometric parameters such as the minimum wall thickness of the final part, initial stock height, and bottom machining height. By applying the appropriate machining ratio for the material type, the illustrative examples calculate stock to leave from roughing to finishing operations across multiple machining levels.

Some of the illustrative examples incorporate a physics-based modeling and simulation approach to compute dynamic cutting forces during side milling. These illustrative examples provide numerical and graphical representations of resulting deflections, enabling enhanced material design optimization. By capturing compliance and dynamic stiffness digitally, the illustrative examples ensure that the part can withstand cutting forces without causing milling vibrations or chatter. The methods of the illustrative examples offer a comprehensive solution for maintaining part stability, paving the way for advanced Numerical Control (NC) automation in rapid manufacturing processes.

The illustrative examples address the challenge of maintaining part stability during side milling of multiple levels for thin-walled part features in rapid manufacturing processes.

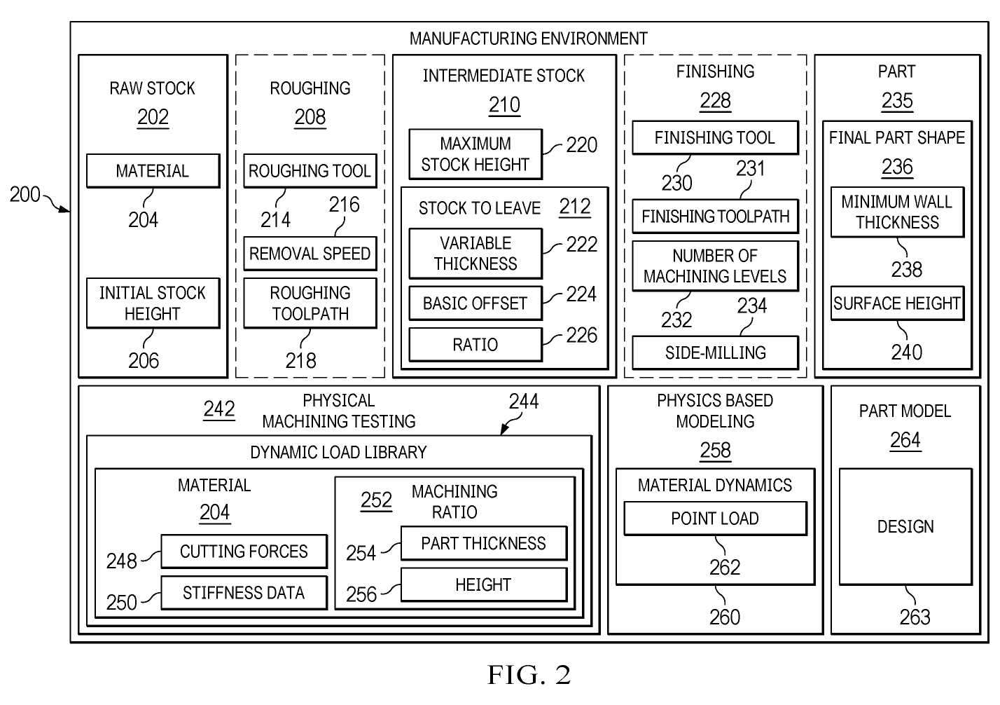

Turning now to FIG. 2, an illustration of a block diagram of a manufacturing environment is depicted in accordance with an illustrative embodiment.

Raw stock 202 formed of material 204 will be machined to form part 235 having final part shape 236. Roughing 208 is performed on raw stock 202 to form intermediate stock 210. Finishing 228 is performed on intermediate stock 210 to form part 235 having final part shape 236. Prior to performing roughing 208, raw stock 202 has initial stock height 206.

Roughing 208 is performed with roughing tool 214 and removal speed 216. Roughing toolpath 218 is determined based on stock to leave 212. Stock to leave 212 is determined automatically based on part model 264 and at least one of physical machining testing 242 or physics based modeling 258.

Intermediate stock 210 generated through roughing 208 has maximum stock height 220. Intermediate stock 210 has stock to leave 212 around final part shape 236. In some illustrative examples, stock to leave 212 comprises basic offset 224 from minimum wall thickness 238. In some illustrative examples, basic offset 224 is the least complicated calculation for stock to leave 212. In some illustrative examples, stock to leave 212 can have variable thickness 222. In some illustrative examples, variable thickness 222 can be possible based on physics based modeling 258.

Stock to leave 212 for intermediate stock 210 is established to at least one of reduce or prevent chatter, part distortion, or undesirable vibrations during finishing 228.

Finishing 228 is performed using finishing tool 230. In some illustrative examples, finishing tool 230 takes the form of a milling tool. Finishing 228 removes stock to leave 212 in number of machining levels 232. In some illustrative examples, finishing 228 takes the form of side milling 234. Side milling 234 may be referred to as thin wall side milling. Finishing 228 is performed by directing finishing tool 230 along finishing toolpath 231. Finishing toolpath 231 is generated based on stock to leave 212, minimum wall thickness 238 of part 235, maximum stock height 220, and number of machining levels 232. In some illustrative examples, minimum wall thickness 238 can be extracted from part model 264.

The illustrative examples provide an automated solution that defines stock to leave 212, adapting to the specific characteristics of different material types and geometric configurations for machining during side milling applications. The illustrative examples automatically calculate stock to leave 212 by roughing 208 based on a desired finishing method for finishing 228, whether machining by regions or by levels. The automation of the illustrative examples eliminates the utilization of user input, standardizes the process, and ensures consistent outcomes.

The illustrative examples provide two different options for setting stock to leave 212. The illustrative examples present both dynamic load library 244 with constant machining ratio 252 and physics based modeling 258 and simulation approach. The illustrative examples capture compliance and dynamic stiffness digitally, ensuring that parts can withstand cutting forces without causing milling vibrations or chatter. The illustrative examples enable enhanced Numerical Control (NC) automation, generative AI modeling concepts and machine learning that can significantly improving efficiency and reliability in rapid manufacturing processes.

The illustrative examples provides methods to automatically maintain part stability during side milling of multiple levels for thin-walled part features in rapid manufacturing processes. One of the initial steps is to digitally capture the compliance and dynamic stiffness of the part in its final shape compared to its raw form and material type. Given the complexity of machine part applications, varying levels of commercial software capabilities, and the wide range of user knowledge in Finite Element Analysis (FEA), Computer-Aided Design (CAD), and Computer-Aided Manufacturing (CAM), the invention offers two adaptable methods for industry use.

One method for establishing stock to leave 212, physical machining testing 242, comprises capturing data derived from physical machining, testing, and measurements to establish dynamic load library 244 of stiffness data 250. Dynamic load library 244 enables determination of a constant machining ratio, machining ratio 252 of part thickness 254 to height 256 ensuring part stability during side milling. Machining ratio 252 of part thickness 254 to height 256 is dependent upon material type and cutting forces. The illustrative examples analyze geometric parameters such as minimum wall thickness 238 of a final part, part 235, initial stock height 206, and bottom machining height, surface height 240. By applying the appropriate material type and cutting conditions, dynamic load library 244 can calculate machining ratio 252 for stock to leave 212 from roughing 208 to finishing 228 across multiple machining levels.

The selection of the manufacturing process, such as wall finishing methods or machining by regions or levels, also determines the appropriate in-process stock to leave conditions. This approach requires less software computation and mechanical engineering expertise to capture the necessary information.

Physical machining testing 242 involves developing dynamic load library 244 of constant machining ratios for various materials. Although dynamic load library 244 is depicted as having only one material, material 204, dynamic load library 244 can have a plurality of different materials. Each material for the plurality of materials would be tested at different cutting forces, different thicknesses, and with different tools. Each material's properties react differently during side milling, and dynamic load library 244 provides the data to maintain part stability for each of the respective materials. By analyzing geometric parameters such as maximum stock height (MH) 220, bottom split surface height (SSH) called surface height 240, number of machining levels (NL) 232, ratio (RTO) 226, and minimum wall thickness (MT) 238, the method calculates the stock to leave 212 from roughing 208 to finishing 228 operations. This approach standardizes the process and reduces the use of extensive software computation and mechanical engineering expertise.

Physical machining testing 242 involves laboratory machine testing to develop a library of constant machining ratios, including machining ratio 252, for various material types based on tested and measured cutting forces 248 applied from side milling. This process includes conducting physical machining tests to determine machining ratio 252 that defines the maximum depth to minimum width of stock that a material should retain to maintain part stability during a machining process. The data from these tests establish a dynamic load library 244 comprising stiffness data 250, providing machining ratio 252 of part thickness 254 to height 256 for various materials, including material 204. The illustrative examples can analyze geometric parameters such as minimum wall thickness (MT) 238, maximum stock height (MH) 220, bottom split surface height (SSH) 240, and the number of machining levels (NL) 232 to automatically define stock to leave (STL) 212 for any new model. Specific formulas can be developed for calculating stock to leave 212 for different finishing methods, such as machining by regions or levels. For this illustrative example, the input parameters as described above can be automatically applied to CAM volumetric toolpath roughing algorithms along with the final three-dimensional part model 264 maintaining part stability during side milling.

Another method of the illustrative examples applies physics based modeling 258 that computes point load 262 representative of the dynamic cutting forces during side milling operations. Physics based modeling 258 utilizes calculations to model material dynamics 260. The dynamic cutting forces are applied to part model 264, providing numerical and graphical representations of the resulting deflection. Software and testing for machining dynamics, including tap test equipment and dynamometers for various cutting tools and material types, assist in representing these cutting forces. The primary output of this illustrative example is a compliant in-process stock model that represents the cutting forces of the manufacturing process, suitable for CAM automation. This illustrative example allows for enhanced material design optimization within the in-process stock model, accommodating more complex shapes and thicknesses for a near-net application from roughing to finishing side milling operations. Accordingly, stock to leave 212 determined using physics based modeling 258 can have variable thickness 222 and a more precisely refined geometry.

By digitally capturing compliance and dynamic stiffness, the illustrative examples ensure that parts can withstand cutting forces without causing milling vibrations or chatter. For example, by digitally capturing compliance and dynamic stiffness, the illustrative examples ensure that part 235 can withstand cutting forces from finishing 228 on intermediate stock 210 without milling vibrations or chatter. While physical machining testing 242 can produce offset parameters for stock to leave 212 that are inputs to a CAM toolpath algorithm applied to a final part model, part model 264, physics based modeling 258 is used as the CAM volumetric toolpath algorithms geometry to be machined while maintaining part stability during side milling.

The resulting numerical and graphical representations of deflection from physics based modeling 258 provide a detailed understanding of how part 235 will behave under machining conditions. A key Finite Element Analysis (FEA) simulation for physics based modeling 258 can take into account and utilize material properties comprising at least one of Young's modulus, Poisson's ratio, density, yield strength, or ultimate tensile strength. A key Finite Element Analysis (FEA) simulation for physics based modeling 258 can take into account and utilize geometric parameters comprising at least one of minimum wall thickness 238 of the final part, part 235, initial stock height, bottom machining height, or overall dimensions of the part. A key Finite Element Analysis (FEA) simulation for physics based modeling 258 can take into account and utilize boundary conditions comprising at least one of constraints (at least one of fixed supports, symmetry conditions, or others) or load applications (at least one of dynamic cutting forces, point loads, distributed loads, or others). A key Finite Element Analysis (FEA) simulation for physics based modeling 258 can take into account and utilize machining parameters comprising at least one of cutting speed, feed rate, depth of cut, or tool geometry and material. A key Finite Element Analysis (FEA) simulation for physics based modeling 258 can take into account and utilize simulation settings comprising at least one of mesh density and quality, time step for dynamic analysis, or solver settings (linear or nonlinear analysis). A key Finite Element Analysis (FEA) simulation for physics based modeling 258 can take into account and utilize cutting force data comprising at least one of measured cutting forces from physical machining tests, or data from dynamometers and tap test equipment. A key Finite Element Analysis (FEA) simulation for physics based modeling 258 can generate a primary output of a “MESH” model output of in process stock. The “MESH” model output comprises at least one of numerical and graphical representations of deflections, stress and strain distributions, or vibration and chatter analysis.

Both methods provide compliance information used for automation within CAM toolpaths to maintain the stiffness required for side milling applications of thin-walled structures and various material types. The results of the initial step digitally capture the dynamic stiffness to be compliant with the intended machining process, ensuring that the part can withstand cutting forces without causing milling vibrations or chatter. The illustrative examples offer a technically advanced solution to existing methods, paving the way for improved Numerical Control (NC) automation.

The illustrative examples provide physical machine testing 242 and physics based modeling 258 to maintain part stability during side milling of multiple levels for thin-walled part features, overcoming the limitations of existing solutions that rely heavily on manual input and lack standardization.

These dual methods automate the process of determining stock to leave 212, standardize the approach, and provide enhanced material design optimization, enabling advanced Numerical Control (NC) automation in rapid manufacturing processes. The illustrative examples automatically maintain part stability during side milling of multiple levels for thin-walled part features in rapid manufacturing processes. The illustrative examples can determine stock to leave 212 for various materials and finishing methods. The illustrative examples digitally capture the stiffness compliance of the part to be machined, which is used for ensuring that the part can withstand cutting forces without causing milling vibrations or chatter. The illustrative examples provide for optimizing the part's shape and thickness prior to machining, allowing it to withstand the cutting forces without causing milling vibrations or chatter. The illustrative examples significantly improve the efficiency and reliability of rapid manufacturing processes.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

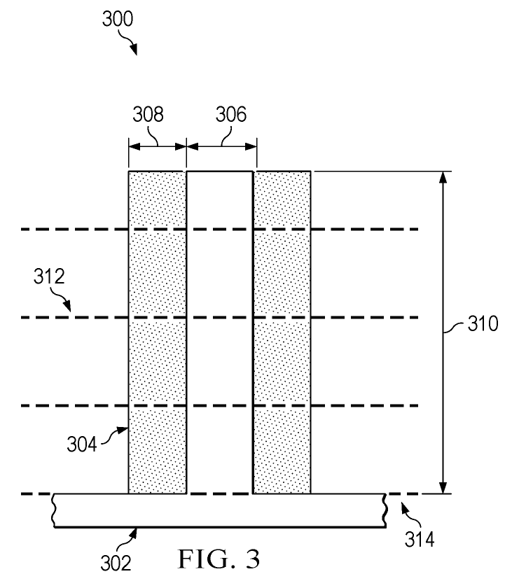

Turning now to FIG. 3, an illustration of a cross-sectional view of a final part shape with stock to leave is depicted in accordance with an illustrative embodiment. In view 300, final part shape 302 and stock to leave 304 are depicted. Final part shape 302 is a physical implementation of final part shape 236 and stock to leave 304 is a physical implementation of stock to leave 212 of FIG. 2.

To model stock to leave 304, minimum wall thickness 306 of final part shape 302 is used. Minimum wall thickness 306 can be extracted from a model of the part.

In this illustrative example, stock to leave 304 has thickness 308. In this illustrative example, stock to leave 304 takes the form of a basic offset. Stock to leave 304 can be modeled either utilizing a machining ratio determined using physical testing or utilizing physics based modeling. Stock to leave 304 is determined based on minimum wall thickness 306, maximum stock height 310, number of machining levels 312, and surface height 314.

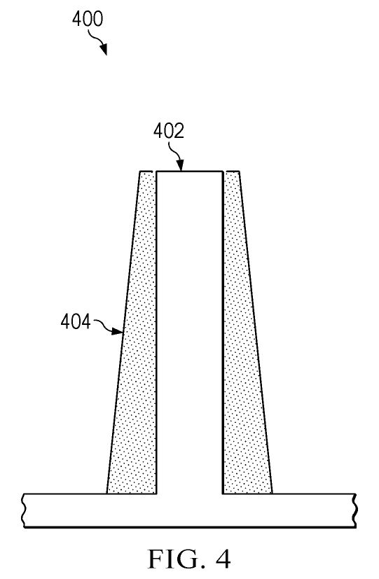

Turning now to FIG. 4, an illustration of a cross-sectional view of a final part shape with stock to leave is depicted in accordance with an illustrative embodiment. In view 400, final part shape 402 and stock to leave 404 are depicted. Final part shape 402 is a physical implementation of final part shape 236 and stock to leave 404 is a physical implementation of stock to leave 212 of FIG. 2.

Stock to leave 404 has a variable thickness in view 400. Stock to leave 404 can be modeled through physics based modeling. Stock to leave 404 is determined based on the minimum wall thickness, maximum stock height, number of machining levels, and surface height. Although stock to leave 404 is symmetrical about final part shape 402, in some illustrative examples stock to leave 404 can differ on either side of final part shape 402. View 400 is only a cross-sectional view of stock to leave 404, stock to leave 404 can vary along a length of final part shape 402 into or out of the page in FIG. 4.

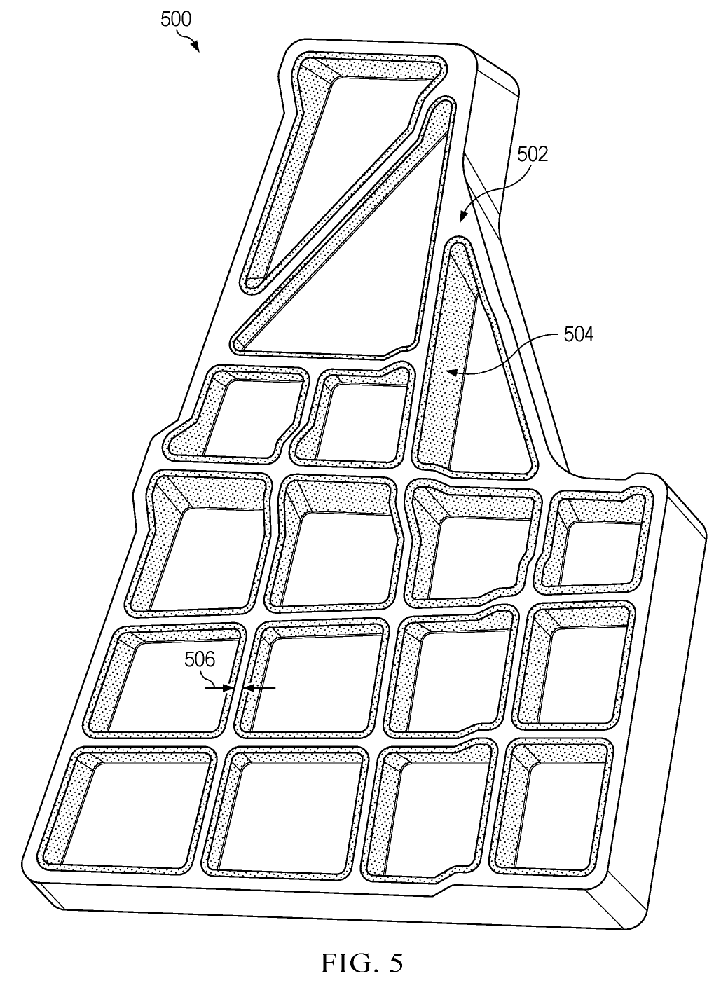

Turning now to FIG. 5, an illustration of a cross-sectional view of a final part shape with stock to leave is depicted in accordance with an illustrative embodiment. In view 500, final part shape 502 and stock to leave 504 are depicted. Final part shape 502 is a physical implementation of final part shape 236 and stock to leave 504 is a physical implementation of stock to leave 212 of FIG. 2.

To model stock to leave 504, minimum wall thickness 506 of final part shape 502 is used. Minimum wall thickness 506 can be extracted from a model of the part.

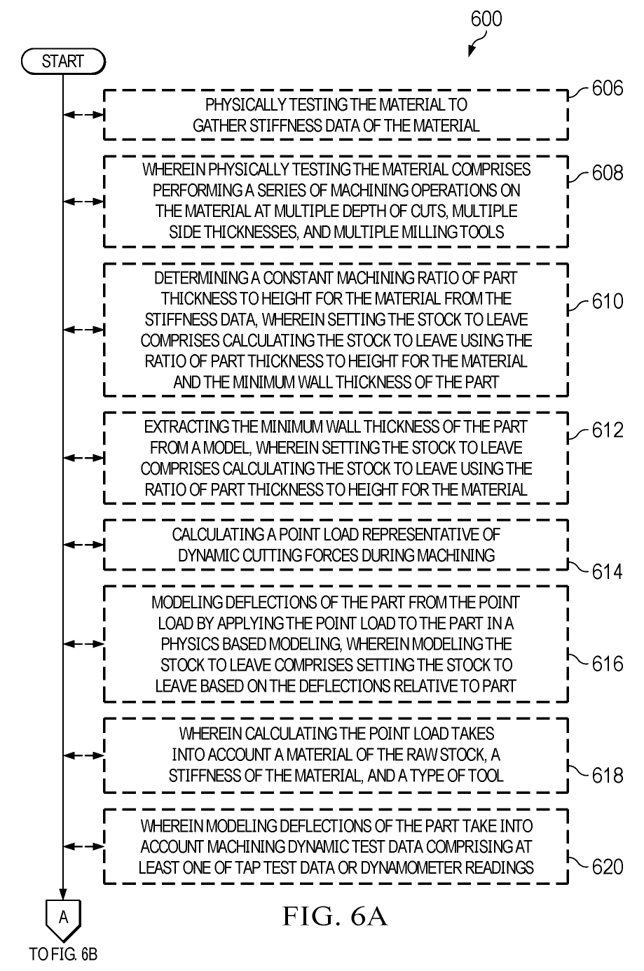

Turning now to FIGS. 6A and 6B, a flowchart of a method of maintaining part stability for side milling is depicted in accordance with an illustrative embodiment. Method 600 can be used to manufacture a component of aircraft 100 of FIG. 1. Method 600 can be used to maintain part stability for side milling with stock to leave 212 and design 263 for part 235 of FIG. 2. In these illustrative examples, the minimum wall thickness can be minimum wall thickness 238 of FIG. 2. Method 600 can be used to maintain part stability for side milling with stock to leave 304 and final part shape 302 of FIG. 3. Method 600 can be used to maintain part stability for side milling with stock to leave 404 and final part shape 402 of FIG. 4. Method 600 can be used to maintain part stability for side milling with stock to leave 504 and final part shape 502 of FIG. 5.

Method 600 models stock to leave for a roughing operation of a part based on material properties of the material of a raw stock and a design of the part (operation 602). Method 600 generates a finishing toolpath for the side milling based on the stock to leave, minimum wall thickness of the part, maximum stock height, and a number of machining levels (operation 604). Afterwards, method 600 terminates.

In some illustrative examples, method 600 physically tests the material to gather stiffness data of the material (operation 606). In some illustrative examples, physically testing the material comprises performing a series of machining operations on the material at multiple depth of cuts, multiple side thicknesses, and multiple milling tools (operation 608).

In some illustrative examples, method 600 determines a constant machining ratio of part thickness to height for the material from the stiffness data, wherein setting the stock to leave comprises calculating the stock to leave using the ratio of part thickness to height for the material and the minimum wall thickness of the part (operation 610). Machining ratio can be described as a desirably small thickness of material while still not generating chatter or undesirable vibration.

In some illustrative examples, method 600 extracts the minimum wall thickness of the part from a model, wherein setting the stock to leave comprises calculating the stock to leave using the ratio of part thickness to height for the material (operation 612). By extracting the minimum wall thickness from the model, method 600 can determine stock to leave without operator input regarding part geometry.

In some illustrative examples, method 600 calculates a point load representative of dynamic cutting forces during machining (operation 614). In some illustrative examples, method 600 models deflections of the part from the point load by applying the point load to the part in a physics based modeling, wherein modeling the stock to leave comprises setting the stock to leave based on the deflections relative to part (operation 616).

In some illustrative examples, calculating the point load takes into account a material of the raw stock, a stiffness of the material, and a type of tool (operation 618). In some illustrative examples, modeling deflections of the part take into account machining dynamic test data comprising at least one of tap test data or dynamometer readings (operation 620). In some illustrative examples, modeling deflections of the part take into account machining dynamic test data comprising at least one of Young's modulus of the material, Poisson's ratio of the material, density of the material, yield strength of the material, ultimate tensile strength of the material, tap test data, or dynamometer readings. In some illustrative examples, machining dynamic test data can comprise at least one of cutting force coefficients, tool geometry and material, spindle speed and feed rate, vibration data, surface roughness data, Finite Element Analysis (FEA) results, residual stress data, or machine tool stiffness and damping characteristics.

In some illustrative examples, the material properties comprise stiffness of the material (operation 622).

In some illustrative examples, method 600 generates a roughing toolpath for the roughing operation based on the stock to leave and dimensions of the raw stock (operation 624). In some illustrative examples, after generating the roughing toolpath, the roughing process can be performed using the roughing toolpath. A tool selected to perform the roughing process will be directed using the roughing toolpath.

In some illustrative examples, method 600 performs the side milling by directing a milling tool along the finishing toolpath (operation 626).

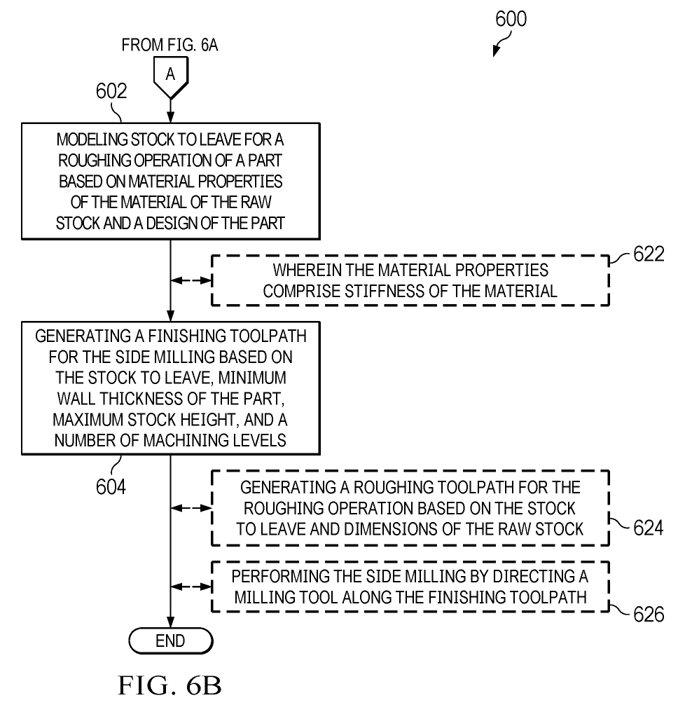

Turning now to FIG. 7, a flowchart of a method of maintaining part stability for side milling is depicted in accordance with an illustrative embodiment. Method 700 can be used to manufacture a component of aircraft 100 of FIG. 1. Method 700 can be used to maintain part stability for side milling with model stock to leave 212 and design 263 for part 235 of FIG. 2. Method 700 can be used to maintain part stability for side milling with stock to leave 304 and final part shape 302 of FIG. 3. Method 700 can be used to maintain part stability for side milling with stock to leave 404 and final part shape 402 of FIG. 4. Method 700 can be used to maintain part stability for side milling with stock to leave 504 and final part shape 502 of FIG. 5.

Method 700 performs a series of physical machining tests to gather stiffness data for a material over a series of thicknesses and a series of cutting forces (operation 702). The series of physical machining tests comprise a plurality of thicknesses and depths of cut for the material. The series of physical machining tests with the plurality of thicknesses and depths of cuts can be used to determine the nearest shape that will withstand the cutting forces applied by a finishing cutter so it does not cause chatter or undesirable surface imperfections.

Method 700 establishes a machining ratio for the material based on the stiffness data, the machining ratio comprising a ratio of part thickness to stock height (operation 704). Machining ratio can be described as a desirably small thickness of material while still not generating chatter or undesirable vibration.

Method 700 sets stock to leave for a roughing operation of a part based on the machining ratio for the material and a design of the part (operation 706). Afterwards, method 700 terminates.

In some illustrative examples, method 700 extracts the minimum wall thickness of the part from a model, wherein setting the stock to leave comprises calculating the stock to leave using the ratio of part thickness to height for the material (operation 708). By extracting the minimum wall thickness from the model, method 700 can determine stock to leave without operator input regarding part geometry.

In some illustrative examples, performing the series of physical machining tests comprises performing the series of physical machining tests with a plurality of tools having a respective tool type and a respective size (operation 710). In these illustrative examples, each machining ratio is determined based on the material, the machining forces, and the respective tool.

In some illustrative examples, method 700 generates a finishing toolpath for the side milling based on the stock to leave, minimum wall thickness of the part, maximum stock height, and a number of machining levels (operation 712). In some illustrative examples, after generating the finishing toolpath, the finishing process can be performed using the finishing toolpath. A tool selected to perform the finishing process will be directed using the finishing toolpath.

In some illustrative examples, method 700 generates a roughing toolpath for the roughing operation based on the stock to leave and dimensions of a raw stock (operation 714). In some illustrative examples, after generating the roughing toolpath, the roughing process can be performed using the roughing toolpath. A tool selected to perform the roughing process will be directed using the roughing toolpath.

Method 700 provides an automated method to define the appropriate stock to leave from roughing operations for finishing operations to adaptively maintain part stability with side milling of multiple levels for thin-walled part features for rapid manufacturing processes. Method 700 maintains part stability by setting the stock in operation 706.

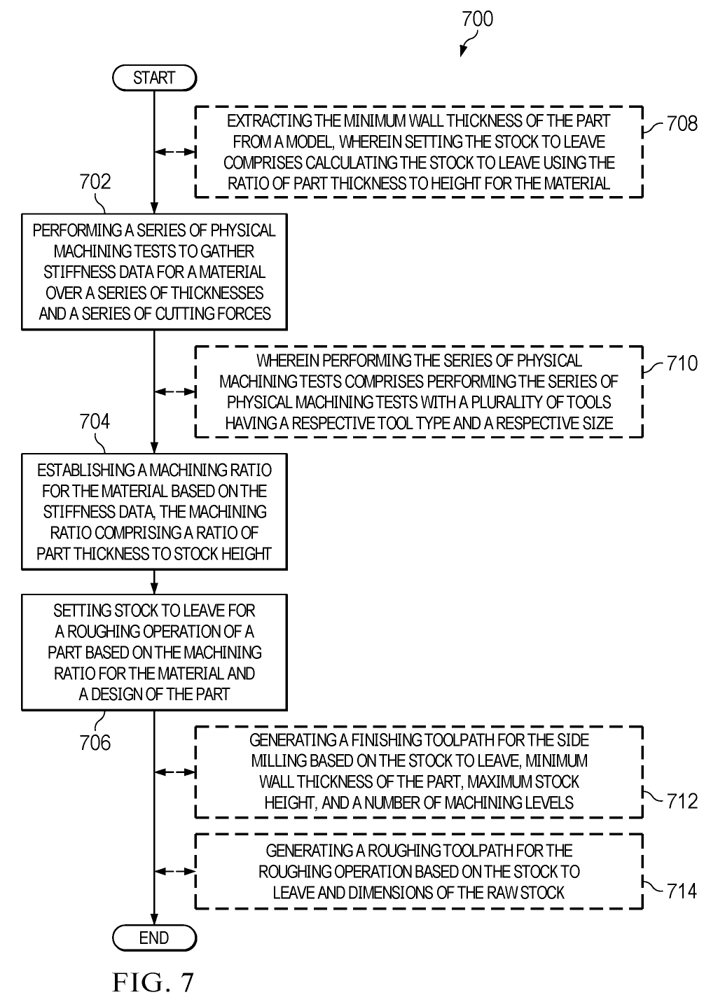

Turning now to FIG. 8, a flowchart of a method of maintaining part stability for side milling is depicted in accordance with an illustrative embodiment. Method 800 can be used to manufacture a component of aircraft 100 of FIG. 1. Method 800 can be used to maintain part stability for side milling with stock to leave 212 and design 263 for part 235 of FIG. 2. Method 800 can be used to maintain part stability for side milling with stock to leave 304 and final part shape 302 of FIG. 3. Method 800 can be used to maintain part stability for side milling with stock to leave 404 and final part shape 402 of FIG. 4. Method 800 can be used to maintain part stability for side milling with stock to leave 504 and final part shape 502 of FIG. 5.

Method 800 calculates a point load representative of dynamic cutting forces during machining (operation 802). Method 800 models deflections of a part from the point load by applying the point load to the part in a physics based modeling (operation 804).

Method 800 sets stock to leave for a roughing operation of the part from raw stock based on the deflections (operation 806). Modeling a near net shape of the stock involves creating an intermediate shape that accounts for deflections during roughing operations. Modeling demonstrates the material can withstand cutting forces, minimizing chatter and surface imperfections, and leaving a small amount of material for the final finishing operation to achieve high-quality and precise dimensions. Afterwards, method 800 terminates.

In some illustrative examples, calculating the point load takes into account a material of a raw stock, a stiffness of the material, and a type of tool (operation 808). In some illustrative examples, modeling deflections of the part take into account machining dynamic test data comprising at least one of Young's modulus of the material, Poisson's ratio of the material, density of the material, yield strength of the material, ultimate tensile strength of the material, tap test data or dynamometer readings (operation 810). In some illustrative examples, machining dynamic test data can comprise at least one of cutting force coefficients, tool geometry and material, spindle speed and feed rate, vibration data, surface roughness data, Finite Element Analysis (FEA) results, residual stress data, or machine tool stiffness and damping characteristics.

In some illustrative examples, method 800 generates a finishing toolpath for the side milling based on the stock to leave, minimum wall thickness of the part, maximum stock height, and a number of machining levels (operation 812). In some illustrative examples, after generating the finishing toolpath, the finishing process can be performed using the finishing toolpath. A tool selected to perform the finishing process will be directed using the finishing toolpath.

In some illustrative examples, method 800 generates a roughing toolpath for the roughing operation based on the stock to leave and dimensions of the raw stock (operation 814). In some illustrative examples, after generating the roughing toolpath, the roughing process can be performed using the roughing toolpath. A tool selected to perform the roughing process will be directed using the roughing toolpath.

Method 800 provides an automated method to define the appropriate stock to leave from roughing operations for finishing operations to adaptively maintain part stability with side milling of multiple levels for thin-walled part features for rapid manufacturing processes. Method 800 maintains part stability by setting the stock in operation 806.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 606 through operation 626 may be optional. As another example, operation 708 through operation 714 may be optional. As another example, operation 808 through operation 814 may be optional.

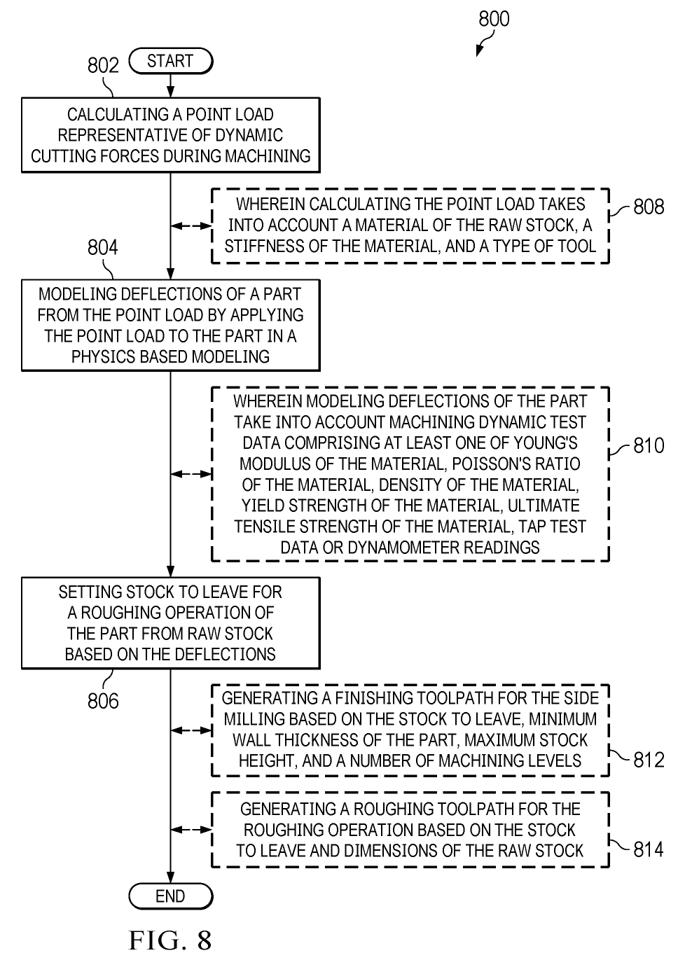

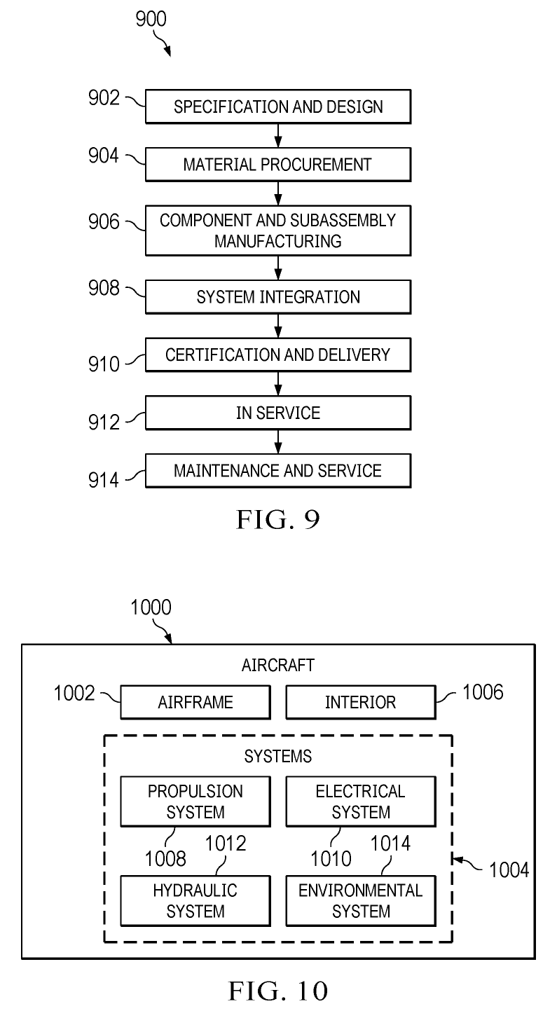

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples provide an automated method to maintain part stability during side milling of thin-walled features in rapid manufacturing. Some of the illustrative examples use constant machining ratios tailored to different materials and analyze geometric parameters to calculate optimal stock levels from roughing to finishing.

Some of the illustrative examples employ physics-based modeling to compute dynamic cutting forces, offering numerical and graphical deflection data. Utilizing physics-based modeling ensures parts can withstand cutting forces without vibrations, enabling advanced NC automation.

The illustrative examples provide methods to automatically maintain part stability during side milling of thin-walled part features in rapid manufacturing processes. The illustrative examples provide automated methods to define the appropriate stock to leave from roughing operations for finishing operations to adaptively maintain part stability with side milling of multiple levels for thin-walled part features for rapid manufacturing processes. The shape and size of the part can vary the method of finishing walls for optimization and/or part distortion to machine by regions or by levels. Machining by region or by levels involve different stock to leave variables to maintain the machining ratio for part stability. The illustrative examples automatically calculate the roughing stock to leave based on either finishing methods desired. The illustrative examples automate and standardize processes to eliminate determination of user input of stock to leave for computer aided manufacturing roughing operations. The illustrative examples provide a technically advanced solution to existing methods paving a path forward for Numerical Control automation.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of maintaining part stability for side milling comprising:
modeling stock to leave for a roughing operation of a part based on material properties of the material of a raw stock and a design of the part; and
generating a finishing toolpath for the side milling based on the stock to leave, minimum wall thickness of the part, maximum stock height, and a number of machining levels.

2. The method of claim 1 further comprising:
generating a roughing toolpath for the roughing operation based on the stock to leave and dimensions of the raw stock.

3. The method of claim 1 further comprising:
performing the side milling by directing a milling tool along the finishing toolpath.

4. The method of claim 1, wherein the material properties comprise stiffness of the material.

5. The method of claim 1 further comprising:
physically testing the material to gather stiffness data of the material.

6. The method of claim 5, wherein physically testing the material comprises performing a series of machining operations on the material at multiple depth of cuts, multiple side thicknesses, and multiple milling tools.

7. The method of claim 5 further comprising:
determining a constant machining ratio of part thickness to height for the material from the stiffness data, wherein setting the stock to leave comprises calculating the stock to leave using the ratio of part thickness to height for the material and the minimum wall thickness of the part.

8. The method of claim 1 further comprising:
extracting the minimum wall thickness of the part from a model, wherein setting the stock to leave comprises calculating the stock to leave using a ratio of part thickness to height for the material.

9. The method of claim 1 further comprising:
calculating a point load representative of dynamic cutting forces during machining; and
modeling deflections of the part from the point load by applying the point load to the part in a physics based modeling, wherein setting the stock to leave comprises modeling the stock to leave based on the deflections relative to part.

10. The method of claim 9, wherein calculating the point load takes into account a material of the raw stock, a stiffness of the material, and a type of tool.

11. The method of claim 10, wherein modeling deflections of the part take into account machining dynamic test data comprising at least one of tap test data or dynamometer readings.

12. A method of maintaining part stability for side milling comprising:
performing a series of physical machining tests to gather stiffness data for a material over a series of thicknesses and a series of cutting forces;
establishing a machining ratio for the material based on the stiffness data, the machining ratio comprising a ratio of part thickness to stock height; and
setting stock to leave for a roughing operation of a part based on the machining ratio for the material and a design of the part.

13. The method of claim 12 further comprising:
generating a finishing toolpath for the side milling based on the stock to leave, minimum wall thickness of the part, maximum stock height, and a number of machining levels.

14. The method of claim 12 further comprising:
generating a roughing toolpath for the roughing operation based on the stock to leave and dimensions of a raw stock.

15. The method of claim 12, wherein performing the series of physical machining tests comprises performing the series of physical machining tests with a plurality of tools having a respective tool type and a respective size.

16. The method of claim 12 further comprising:
extracting the minimum wall thickness of the part from a model, wherein setting the stock to leave comprises calculating the stock to leave using the ratio of part thickness to height for the material.

17. A method of maintaining part stability for side milling comprising:
calculating a point load representative of dynamic cutting forces during machining;
modeling deflections of a part from the point load by applying the point load to the part in a physics based modeling; and
setting stock to leave for a roughing operation of the part from raw stock based on the deflections.

18. The method of claim 17, wherein calculating the point load takes into account a material of a raw stock, a stiffness of the material, and a type of tool.

19. The method of claim 18, wherein modeling deflections of the part take into account machining dynamic test data comprising at least one of Young's modulus of the material, Poisson's ratio of the material, density of the material, yield strength of the material, ultimate tensile strength of the material, tap test data, or dynamometer readings.

20. The method of claim 17 further comprising:
generating a finishing toolpath for the side milling based on the stock to leave, minimum wall thickness of the part, maximum stock height, and a number of machining levels.

21. The method of claim 17 further comprising:
generating a roughing toolpath for the roughing operation based on the stock to leave and dimensions of a raw stock.
